(19) United States
(12) Patent Application Publication
(10) Pub. No.: US 2010/0244328 A1
(43) Pub. Date: Sep. 30, 2010

(54) CURABLE COMPOSITION FOR PHOTOIMPRINT, AND METHOD FOR PRODUCING CURED PRODUCT USING SAME

(75) Inventors: Hiroyuki YONEZAWA, Haibara-gun (JP); Akinori Fujita, Haibara-gun (JP); Takashi Takayanagi, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/729,870

(22) Filed: Mar. 23, 2010

(30) Foreign Application Priority Data
Mar. 25, 2009 (JP) 2009-074969
Jul. 22, 2009 (JP) 2009-170986
Aug. 18, 2009 (JP) 2009-189066
Oct. 7, 2009 (JP) 2009-233517

(51) Int. Cl. B29C 59/16; C08J 3/28

(52) U.S. Cl. 264/447; 522/153

(57) ABSTRACT

A curable composition for photoimprints comprising a photopolymerizable monomer, a polymerization initiator and a compound of the following formula (1), wherein the content of compounds having a molecular weight of at least 1000 is at most 10% by mass of all the solid content therein, and the content of the compound of the formula (1) is from 0.3 to 10.0% by mass of all the solid content therein:

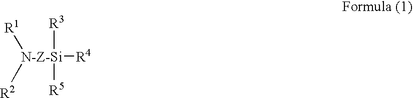

wherein Z represents an aliphatic hydrocarbon group; R¹ and R² represent a hydrogen atom or a substituent; R³ and R⁴ represent a methyl group, an ethyl group, a methoxy group or an ethoxy group; and R⁵ represents a methoxy group or an ethoxy group.

### CROSS-REFERENCE TO RELATED APPLICATIONS

The present application claims the benefit of priority from Japanese Patent Application No. 2009-074969 filed on Mar. 25, 2009, Japanese Patent Application No. 2009-170986 filed on Jul. 22, 2009, Japanese Patent Application No. 2009-189066 filed on Aug. 18, 2009, and Japanese Patent Application No. 2009-233517 filed on Oct. 7, 2009, the contents of which are herein incorporated by reference in their entirety.

### BACKGROUND OF THE INVENTION

1. Field of the Invention

The present invention relates to a curable composition for photoimprints, and to a method for producing a cured product using it.

2. Description of the Related Art

An imprinting method is a technique developed from an embossing technique well known in production of optical discs, and the method comprises pressing a mold original with embossing patterns formed thereon (generally it may be referred to also as mold, stamper or template) against a resist to thereby mechanically deform it for precision transfer of the micropatterns onto the resist. Once the mold is produced, nanostructures can be repeatedly shaped with it in a simplified manner, and the method is therefore economical and is a nanoprocessing technique discharging few harmful wastes and emissions, and this is expected to be applicable to various fields.

Of the imprinting method, in particular, a photoimprinting system that comprises photocuring a curable composition for imprints by irradiation with light through a transparent mold, is useful as enabling imprinting at room temperature (M. Colbun, et al.; Proc. SPIE, Vol. 676, 78 (1999)). These days photonanoimprinting is being applied to production of high-density semiconductor integrated circuits and to production of transistors or in-cell protective films for use in liquid-crystal displays, in place of conventional lithography, and the approach to practical use of the technology is now much activated. Accordingly, the demand for curable compositions for use for photoimprints is increasing year by year. However, providing a curable composition excellent in imprintability often involves a problem of other requirements such as adhesiveness to substrate, etc. In addition, industrialization of imprinting technology also involves a problem of temporal stability, etc.

On the other hand, JP-A 2007-316247 discloses a photosensitive resin composition containing a binder resin, a photopolymerizable monomer, a photopolymerization initiator and an organosilane compound having a specific structure.

### SUMMARY OF THE INVENTION

The present invention has been made in consideration of the above-mentioned situation, and its object is to provide a novel curable composition for imprints excellent in photocurability, imprintability, adhesiveness to substrate and temporal stability.

Given the situation as above, the inventors have assiduously studied and, as a result, have found that the following means can solve the above-mentioned problems.

(1) A curable composition for photoimprints comprising (A) a photopolymerizable monomer, (B) a polymerization initiator and (C) a compound of the following formula (1), wherein the content of compounds having a molecular weight of at least 1000 is at most 10% by mass of all the solid content therein, and the content of the compound of the formula (1) in the above (C) is from 0.3 to 10.0% by mass of all the solid content therein:

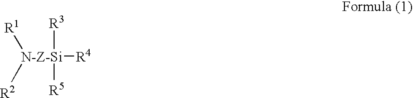

wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; and R⁵ represents a methoxy group or an ethoxy group.

(2) The curable composition for photoimprints of (1), wherein Z in the formula (1) is a linear or branched hydrocarbon group.

(3) The curable composition for photoimprints of (1), wherein Z in the formula (1) is an alkylene group.

(4) The curable composition for photoimprints of any one of (1) to (3), wherein Z in the formula (1) is an aliphatic hydrocarbon group having from 1 to 5 carbon atoms.

(5) The curable composition for photoimprints of any one of (1) to (4), wherein at least one of R¹ and R² in the formula (1) is a substituent containing a (meth)acryloyloxy group.

(6) The curable composition for photoimprints of any one of (1) to (4), wherein at least one of R¹ and R² in the formula (1) is a substituent containing an alkoxysilyl group.

(7) The curable composition for photoimprints of (1), wherein the compound of the formula (1) is a compound represented by the following formula (2):

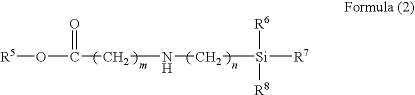

wherein R⁵ represents a substituent, R⁶ and R⁷ each independently represent a methyl group, an ethyl group, a methoxy group or an ethoxy group; R⁸ represents a methoxy group or an ethoxy group; m and n each independently indicate an integer of from 1 to 4.

(8) The curable composition for photoimprints of anyone of (1) to (7), further comprising a surfactant.

(9) The curable composition for photoimprints of any one of (1) to (8), wherein at least one of the photopolymerizable monomer (A) is an urethane (meth)acrylate monomer.

(10) The curable composition for photoimprints of (9), wherein the urethane (meth) acrylate is tri- or more functional.

(11) The curable composition for photoimprints of (9) or (10), wherein the content of the urethane (meth) acrylate is from 1 to 30% by weight of the total amount of the photopolymerizable monomer (A).

(12) A method for producing a cured product, comprising using the curable composition for photoimprints of any one of to (11).

(13) A method for producing a cured product, comprising applying the curable composition for photoimprints of any one of (1) to (11), onto a substrate to form a patterning layer thereon, pressing a mold against the surface of the patterning layer, and irradiating the patterning layer with light.

(14) The method for producing a cured product of (13), which further includes heating the light-irradiated pattering layer.

A curable composition for photoimprints exhibiting good patterning accuracy can be provided by the invention.

### BEST MODE FOR CARRYING OUT THE INVENTION

The contents of the invention are described in detail hereinunder. In this specification, the numerical range expressed by the wording “a number to another number” means the range that falls between the former number indicating the lowermost limit of the range and the latter number indicating the uppermost limit thereof. In this specification, mass ratio is equal to weight ratio. In this specification, mass ratio is equal to weight ratio.

In this specification, “(meth)acrylate” means acrylate and methacrylate; “(meth)acrylic” means acrylic and methacrylic; “(meth)acryloyl” means acryloyl and methacryloyl.

In the invention, monomer is differentiated from oligomer and polymer, and the monomer indicates a compound having a weight-average molecular weight of at most 1,000. In this specification, “functional group” means a group participating in polymerization.

“Imprint” referred to in the invention is preferably meant to indicate pattern transfer in a size of from 1 nm to 10 mm and more preferably meant to indicate pattern transfer in a size of from about 10 nm to 100 μm (nanoimprint).

### [Curable Composition for Photoimprints]

The curable composition for photoimprints of the invention (which may be referred to as “the composition of the invention” hereinafter) comprises (A) a photopolymerizable monomer, (B) a polymerization initiator and (C) a compound of the following formula (1), wherein the content of compounds having a molecular weight of at least 1000 is at most 10% by mass of all the solid content therein, and the content of the compound of the formula (1) in the above (C) is from 0.3 to 10.0% by mass of all the solid content therein:

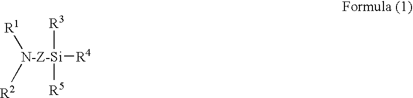

wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; and R⁵ represents a methoxy group or an ethoxy group.

The curable composition for photoimprints of the invention is widely usable in photoimprint lithography, and has the following characteristics.

(1) The composition of the invention is excellent in solution flowability at room temperature, and therefore the composition can readily flow into the cavity of the recesses of a mold. Since air is hardly taken into the cavity, the composition is free from bubble defects, and in both the projections and recesses of the mold, the composition residue remains little after photocuring.

(2) The cured film formed by curing the composition of the invention is excellent in mechanical properties, and the adhesiveness between the coating film and the substrate is excellent. In addition, since the coating film is excellent in peelability from mold, the film is free from a trouble of pattern deformation or surface roughening owing to stringiness on the surface of the coating film in mold peeling, and therefore the composition can form a good pattern (good imprintability).

(3) The composition is excellent in uniform coatability, and is therefore suitable to the field of application to large-size substrates and to the field of microprocessing.

(4) The composition has good mechanical properties such as photocurability, heat resistance and elasticity recovery, and it is favorable for various permanent films.

(5) The composition is excellent in voltage characteristics, and is suitable for materials for electronic circuits.

Accordingly, the curable composition for photoimprints of the invention is favorably applied to semiconductor integrated circuits and parts of liquid-crystal display devices (especially to microfabrication for thin-film transistors of liquid-crystal displays, protective films of liquid-crystal color filters, spacers and other parts of liquid-crystal display devices, etc.) to which, however, conventional compositions are heretofore difficult to apply; and in addition, the composition of the invention is further applicable to production of any others, widely for example, partitioning materials for plasma display panels, flat screens, microelectromechanical systems (MEMS), sensor devices, optical discs, magnetic-recording media such as high-density memory discs, optical parts such as diffraction gratings and relief holograms, nanodevices, optical devices, optical films, polarization devices, organic transistors, color filters, overcoat layers, pillar materials, rib materials for liquid-crystal alignment, microlens arrays, immunoassay chips, DNA separation chips, microreactors, nanobio devices, optical waveguides, optical filters, photonic liquid crystals, etc.

The viscosity of the curable composition for photoimprints of the invention is described. Unless otherwise specifically indicated, the viscosity in the invention is at 25° C. Preferably, the viscosity at 25° C. of the curable composition for photoimprints of the invention is from 3 to 50 mPa·s, more preferably from 3 to 30 mPa·s, even more preferably from 3 to 20 mPa·s. When the viscosity of the composition of the invention is less than 3 mPa·s, then it may be problematic in point of the coating applicability to substrate and the mechanical strength of the formed film may lower. Concretely, when the viscosity is at least 3 mPa·s, then the coating unevenness may be prevented in coating with the composition and the composition may be prevented from flowing away from the substrate in coating thereof with the composition. In addition, the composition having a viscosity of not less than 3 mPa·s is easier to produce than the composition having a viscosity of less than 3 mPa·s. On the other hand, in case where the viscosity of the composition of the invention is at most 50 mPa·s, the composition may well flow into the cavity of the recesses of a mold and air is hardly taken into the cavity even when the mold having an embossing micropattern thereon is in tight contact with the composition, and therefore the composition is free from bubble defects, and in the projections of the mold, the composition residue remains little after photocuring. When the viscosity of the composition of the invention is more than 50 mPa·s, the viscosity may have some negative influence on the micropatterning with the composition.

In general, the viscosity of the composition can be controlled by blending various types of monomers and polymers that differ in the viscosity therebetween. For planning the viscosity of the curable composition for photoimprints of the invention to fall within the above range, preferably, a compound having a viscosity of from 2 to 5 mPa·s by itself is added to the composition to regulate the viscosity thereof.

For the purpose of enhancing the optical properties of the composition of the invention and for making the composition releasable from mold, a high-molecular compound such as a polymer may be incorporated in the composition; however, for making the composition have a low viscosity suitable to imprinting, the content of the compound having a molecular weight of 1000 or more must be at most 10% by weight of the total solid content in the composition, more preferably at most 5% by weight.

### (Photopolymerizable Monomer)

The curable composition for photoimprints of the invention contains a photopolymerizable monomer. Containing a photopolymerizable monomer, the composition of the invention may attain good patterning accuracy (imprintability) after irradiation with light. In the invention, “photopolymerizable monomer” means a monomer capable of undergoing polymerization through irradiation with light to form a polymer.

The photopolymerizable monomer for use in the invention is preferably a compound having a viscosity of at most 300 mPa·s from the viewpoint of controlling the viscosity of the composition, more preferably at most 100 mPa·s, even more preferably at most 30 mPa·s.

Preferably, the photopolymerizable monomer in the invention has a radical photopolymerizable functional group such as, for example, an ethylenic unsaturated bond-having functional group. The functional group is preferably a (meth)acrylate group, a vinyl group, an allyl group or a styryl group, more preferably a (meth)acrylate group. The composition of the invention may contain one or more photopolymerizable monomers, and the composition may additionally contain any other photopolymerizable monomer (e.g., cationic polymerizing group-having polymerizing monomer).

From the viewpoint of the mechanical properties of the cured film, preferred is use of a di- or more functional monomer (polyfunctional monomer). The polyfunctional monomer necessarily has a large molecular weight, and the viscosity of the composition containing it is therefore high; and owing to the high viscosity thereof, the patterning accuracy with the composition may lower. Accordingly, the photopolymerizable monomer for use in the invention is comprehensively selected in consideration of the combination of a low-viscosity monomer for viscosity control and a polyfunctional monomer for imparting mechanical properties to the cured film or the combination of an oxetane compound and a functional acid anhydride in the invention.

In the curable composition for photoimprints of the invention, the content of the photopolymerizable monomer in the total solid matter is preferably from 20 to 95% by mass, more preferably from 30 to 70% by mass, from the viewpoint of the patterning accuracy with the composition after irradiation with light.

A polymerizable unsaturated monomer having one ethylenic unsaturated bond-containing group (monofunctional polymerizable unsaturated monomer) can be used as the photopolymerizable monomer of the invention. The monofunctional polymerizable unsaturated monomer may have a group other than the ethylenic unsaturated bond-containing group. Preferable examples of such group include an epoxy group and an oxetanyl group. Examples of the monofunctional polymerizable unsaturated monomer include 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl (meth)acrylate, 2-ethylhexylcarbitol (meth)acrylate, 2-hydroxybutyl(meth)acrylate, 2-hydroxyethyl(meth)acrylate, 2-hydroxypropyl(meth)acrylate, 2-methoxyethyl (meth)acrylate, 3-methoxybutyl(meth)acrylate, 4-hydroxybutyl(meth)acrylate, acrylic acid dimer, benzyl (meth)acrylate, butanediol mono(meth)acrylate, butoxyethyl (meth)acrylate, butyl(meth)acrylate, cetyl(meth)acrylate, glycidyl(meth)acrylate, (meth)acrylate having an oxetanyl group such as (3-methyl-3-oxetanyl)methyl(meth)acrylate and (3-ethl-3-oxetanyl)methyl(meth)acrylate,ethyleneoxide-modified (hereinafter this may be referred to as “EO”) cresol (meth)acrylate, dipropylene glycol (meth)acrylate, ethoxylated phenyl(meth)acrylate, ethyl(meth)acrylate, isoamyl(meth)acrylate, isobutyl(meth)acrylate, isooctyl (meth)acrylate, cyclohexyl(meth)acrylate, isobornyl (meth)acrylate, isobornyl(meth)acrylate, dicyclopentanyl (meth)acrylate, dicyclopentanyloxyethyl(meth)acrylate, isomyristyl(meth)acrylate, lauryl(meth)acrylate, methoxydiproylene glycol (meth)acrylate, methoxytripropylene glycol (meth)acrylate, methoxypolyethylene glycol (meth)acrylate, methoxytriethylene glycol (meth)acrylate, methyl(meth)acrylate, neopentyl glycol benzoate (meth)acrylate, nonylphenoxypolyethylene glycol (meth)acrylate, nonylphenoxypolypropylene glycol (meth)acrylate, octyl(meth)acrylate, paracumylphenoxyethylene glycol (meth)acrylate, epichlorohydrin (hereinafter referred to as “ECH”)-modified phenoxyacrylate, phenoxyethyl(meth)acrylate, phenoxydiethylene glycol (meth)acrylate, phenoxyhexaethylene glycol (meth)acrylate, phenoxytetraethylene glycol (meth)acrylate, polyethylene glycol (meth)acrylate, polyethylene glycol-polypropylene glycol (meth)acrylate, polypropylene glycol (meth)acrylate, stearyl(meth)acrylate, EO-modified succinic acid (meth)acrylate, tert-butyl (meth)acrylate, tribromophenyl(meth)acrylate, EO-modified tribromophenyl(meth)acrylate, tridodecyl(meth)acrylate, p-isopropenylphenol, styrene, α-methylstyrene, acrylonitrile and vinyl carbazole.

Of those, an acrylate monomer is preferably used in the invention.

A polymerizable unsaturated monomer having two ethylenic unsaturated bond-containing group (difunctionalpolymerizable unsaturated monomer) can be also preferably used as the photopolymerizable monomer of the invention. Examples of the difunctional polymerizable unsaturated monomer include diethylene glycol monoethyl ether (meth)acrylate, dimethylol-dicyclopentane di(meth)acrylate, di(meth)acrylated isocyanurate, 1,3-butylene glycol di(meth)acrylate, 1,4-butanediol di(meth)acrylate, 1,6-hexanediol di(meth)acrylate, EO-modified 1,6-hexanediol di(meth)acrylate, ECH-modified 1,6-hexanediol di(meth)acrylate, allyloxy-polyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propyleneoxide (hereinafter referred to as “PO”)-modified neopentyl glycol diacrylate, caprolactone-modified hydroxypivalate neopentyl glycol, stearic acid-modified pentaerythritol di(meth) acrylate, ECH-modified phthalic acid di(meth) acrylate, poly(ethylene glycol-tetramethylene glycol) di(meth)acrylate, poly(propylene glycol-tetramethylene glycol) di(meth)acrylate, polyester di(meth)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, tricyclodecanedimethanol di(meth)acrylate, neopentyl glycol-modified trimethylolpropane di(meth)acrylate, tripropylene glycol di(meth)acrylate, EO-modified tripropylene glycol di(meth) acrylate, triglycerol di(meth)acrylate, dipropylene glycol di(meth)acrylate, divinylethylene-urea, divinylpropylene-urea, dicylopentenyl di(meth)acrylate, dicylopentenyloxyethyl di(meth)acrylate, dicyclopentanyl di(meth)acrylate.

Of those, especially preferred for use in the invention are neopentyl glycol di(meth)acrylate, 1,4-butanediol di(meth)acrylate, 1,6-hexanediol di(meth)acrylate, 1,9-nonanediol di(meth)acrylate, dicylopentenyloxyethyl di(meth)acrylate, dicyclopentanyl di(meth)acrylate, etc.

A polymerizable unsaturated monomer having three ethylenic unsaturated bond-containing group (trifunctional polymerizable unsaturated monomer) can be also preferably used as the photopolymerizable monomer of the invention. Examples of the trifunctional polymerizable unsaturated monomer include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, caprolactone-modified dipentaerythritol hexa(meth)acrylate, dipentaerythritol hydroxy-penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy-tetra(meth)acrylate, pentaerythritol tetra(meth)acrylate, etc.

Of those, especially preferred for use in the invention are trimethylolpropane tri(meth)acrylate, dipentaerythritol hexa(meth)acrylate, pentaerythritol ethoxy-tetra(meth)acrylate, pentaerythritol tetra(meth)acrylate, etc.

In the invention, for the purpose of enhancing the adhesiveness of the resist of the composition to the organic film or the inorganic film formed thereon, especially to the ITO film thereon, an urethane (meth) acrylate is preferably used for the photopolymerizable monomer, more preferably a polyfunctional urethane (meth)acrylate, even more preferably a tri- or more functional urethane (meth)acrylate, still more preferably a tetra- to hexa-functional urethane (meth) acrylate. Preferably, the molecular weight of the urethane (meth)acrylate is from 300 to 1000, more preferably from 400 to 700. Further preferably, the urethane (meth)acrylate is an urethane acrylate.

Preferably, the content of the urethane (meth)acrylate is from 1 to 30% by weight of the total amount of the polymerizing monomer (A), more preferably from 3 to 20% by weight.

For example, U-2PPA, U-4HA, U-6HA, UA-100H, U-6LPA, U-15HA, UA-³²P, U-324A, U-4H, U-6H, U-108A, U-200PA, U-412A, UA-4200, UA-4400, UA-340P, UA-2235PE, UA-160™, UA-122P, UA-5201, UA-512, UA-W2A, UA-W2, UA-7000, UA-7100, UA-7200 (all registered trademarks) available from Shin-Nakamura Chemical; and AH-600, AT-600, UA-306H, UA-306T, UA-306I, UA-510H, UF-8001G available from Kyoei-sha Chemical are usable in the invention. In addition to these, other urethane (meth)acrylates having any arbitrary structure can be selected for use herein. Especially preferred are U-4HA, U-6HA and U-15HA of good photocurability.

Preferred blend embodiments of photopolymerizable monomers in the invention are described below.

The above-mentioned monofunctional polymerizing unsaturated monomer is effective for reducing the viscosity of the composition, and in general, the amount thereof to be added is within a range of from 10 to 100% by mass of all the polymerizing unsaturated monomers, preferably from 10 to 80% by mass, more preferably from 10 to 60% by mass, even more preferably from 10 to 30% by mass.

The above-mentioned monomer having two unsaturated bond-containing groups (difunctional polymerizing unsaturated monomer) is effective for enhancing the mechanical properties of the cured film, and the amount thereof to be added is preferably at least 50% by mass of all the polymerizing unsaturated monomers, more preferably at leas 60% by mass, even more preferably at least 70% by mass. Preferably containing the di- or more functional unsaturated monomer in an amount of at least 50% by mass, the composition may form a cured film having better elasticity recovery. Not specifically defined, the uppermost limit of the content may be generally at most 95% by mass.

### (Polymerization Initiator)

The curable composition for photoimprints comprises a polymerization initiator, particularly photopolymerization initiator. An initiator for photoradical polymerization is generally used as the photopolymerization initiator. Pattern transfer accuracy after irradiation with light is improved by the photopolymerization initiator for initiating a polymerization with irradiation with light which is contained in the curable composition. The content of the photopolymerization initiator in the composition of the invention may be, for example, from 0.1 to 15% by mass, preferably from 0.2 to 12% by mass, more preferably from 0.3 to 10% by mass of all the solid content therein. In the case where two or more different types of photopolymerization initiators are in the composition, their total amount may fall within the above range.

When the proportion of the photopolymerization initiator is at least 0.1% by mass, then it is favorable since the composition tends to better in point of the sensitivity (rapid curability), the resolution, the line edge roughness reduction and the coating film strength. On the other hand, when the proportion of the photopolymerization initiator is at most 15% by mass, then it is also favorable since the composition tends to better in point of the light transmittance, the discoloration resistance and the handlability.

The photopolymerization initiator for use in the invention includes those active to the wavelength of the light source to be used, for which, for example, usable are those capable of generating suitable active species. For example, the materials described in [0091] of JP-A 2008-105414 can be preferably used.

### (Compound of the Formula (1))

The composition of the invention contains a compound of formula (1). Containing the compound of the formula (1), the heat resistance and the strength of the surface structure having an embossed microstructure of the cured film can be enhanced, and the adhesiveness of the composition to a metal deposition film after photoexposure and before curing can be enhanced.

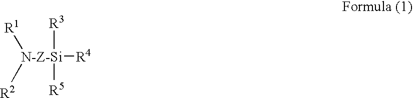

wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; R⁵ represents a methoxy group or an ethoxy group.

Preferably, Z is a linear or branched hydrocarbon group, more preferably a linear or branched alkylene group, even more preferably an unsubstituted alkylene group. The carbon number in Z is generally an integer of from 1 to 10, preferably an integer of from 1 to 5, more preferably an integer of from 1 to 4, even more preferably an integer of from 1 to 3.

Preferably, R³ and R² are each independently a hydrogen atom, or a substituent containing at least one group selected from a (meth) acryloyl group, a (meth) acryloyloxy group, a silanol group, an alkyl group, an epoxy group, an oxetanyl group, a vinyl group, an allyl group, a hydroxyl group and a carboxyl group (the substituent may be further substituted with any other group). More preferably, R³ and R² are each independently a hydrogen atom, or a substituent having a (meth) acryloyloxy group (even more preferably an alkyl group containing a (meth) acryloyloxy group, still more preferably an alkyl group having at least 4 carbon atoms and having a (meth) acryloyloxy group; the carbon number in the (meth) acryloyloxy group-having alkyl group is preferably from 4 to 20, more preferably from 4 to 15, even more preferably from 4 to 13, still more preferably from 4 to 10; also preferably, the (meth) acryloyloxy group-having alkyl group is a linear alkyl group having a (meth) acryloyloxy group at the terminal thereof), or a substituent having a substituted or unsubstituted silanol group (more preferably a substituent having an alkoxy group-substituted silanol group (that is, an alkoxysilyl group), even more preferably an alkoxysilyl group-substituted alkyl group, still more preferably an alkyl group having from 1 to 4 carbon atoms and substituted with an alkoxysilyl group, most preferably an alkyl group having 2 or 3 carbon atoms and substituted with a methoxysilyl group or an ethoxysilyl group).

The content of the compound of the formula (1) is from 0.3 to 10.0% by weight of the entire solid content of the composition, preferably from 0.3 to 5.0% by weight, more preferably from 0.5 to 2.0% by weight. Containing the compound within the range, the adhesiveness of the composition to substrate may be enhanced with inhibiting the viscosity increase thereof.

Preferably, the compound of the formula (1) is a compound represented by the following formula (2) :

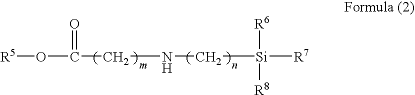

wherein R⁵ represents a substituent, R⁶ and R⁷ each independently represent a methyl group, an ethyl group, a methoxy group or an ethoxy group; R⁸ represents a methoxy group or an ethoxy group; m and n each independently indicate an integer of from 1 to 4.

Preferably, R⁵ is an alkyl group, more preferably an alkyl group having a (meth) acryloyloxy group or an alkyl group substituted with an alkoxysilyl group, even more preferably an alkyl group having at least 4 carbon atoms and having a (meth) acryloyloxy group. Preferably, the carbon number in the (meth) acryloyloxy group-having alkyl group is from 4 to 20, more preferably from 4 to 15, even more preferably from 4 to 13, still more preferably from 4 to 10. Also preferably, the (meth) acryloyloxy group-having alkyl group is a linear alkyl group having a (meth) acryloyloxy group at the terminal thereof.

Preferably, R⁶ and R⁷ are each independently a methoxy group or an ethoxy group.

Preferably, m and n are each independently 2 or 3.

The compound of the formula (1) may be produced according to means known to those skilled in the art, or may be a commercially-available silane coupling agent. The commercial products include, for example, aminosilanes such as N-β (aminoethyl)-γ-aminopropyltrimethoxysilane, N-β-(aminoethyl)-γ-aminopropylmethyldimethoxysilane, γ-aminopropyltrimethoxysilane, N-phenyl-γ-aminopropyltrimethoxysilane, etc.

### (Other Organic Metallic Coupling Agents)

The composition of the invention may contain other organic metal coupling agent added thereto, whereby adhesiveness after curing can be enhanced more effectively. The organic metal coupling agent is effective, as having the effect of promoting the thermosetting reaction of the composition. As the organic metal coupling agent, herein usable are various coupling agents such as a silane coupling agent other than the compounds of the formula (1), a titanium coupling agent, a zirconium coupling agent, an aluminium coupling agent, a tin coupling agent, etc.

The silane coupling agent for use in the composition of the invention includes, for example, vinylsilanes such as vinyltrichlorosilane, vinyltris((β-methoxyethoxy)silane, vinyltriethoxysilane, vinyltrimethoxysilane, etc.; epoxysilanes such as γ-(meth)acryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, etc.; and other silane coupling agents such as γ-mercaptopropyltrimethoxysilane, γ-chloropropylmethyldimethoxysilane, γ-chloropropylmethyldiethoxysilane, etc.

The titanium coupling agent includes, for example, isopropyltriisostearoyl titanate, isopropyltridecylbenzenesulfonyl titanate, isopropyltris(dioctylpyrophosphate) titanate, tetraisopropylbis(dioctylphosphite) titanate, tetraoctylbis(ditridecylphosphite) titanate, tetra(2,2-diallyloxymethyl)bis(ditridecyl)phosphite titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropylisostearoyldiacryl titanate, isopropyltri(dioctylphosphate) titanate, isopropyltricumyl titanate, isopropyltri(N-aminoethyl-aminoethyl) titanate, dicumylphenyloxyacetate titanate, diisostearoylethylene titanate, etc.

The zirconium coupling agent includes, for example, tetra-n-propoxy zirconium, tetra-butoxy zirconium, zirconium tetraacetylacetate, zirconium dibutoxybis(acetylacetonate), zirconium tributoxyethyl acetacetate, zirconium butoxyacetylacetonate bis(ethylacetacetate), etc.

The aluminium coupling agent includes, for example, aluminium isopropylate, mono-sec-butoxyaluminium diisopropylate, aluminium sec-butyrate, aluminium ethylate, ethylacetacetate aluminium diisopropylate, aluminium tris(ethylacetacetate), alkylacetacetate aluminium diisopropylate, aluminium monoacetylacetonate bis(ethylacetacetate), aluminium tris(acetylacetate), etc.

The above-mentioned organic metal coupling agent may be in the curable composition for phdtoimprint in an amount falling within a range of from 0.001 to 10% by mass of the total solid content of the composition. When the proportion of the organic metal coupling agent is at least 0.001% by mass, then it may be more effective for enhancing the heat resistance, the strength and the adhesiveness to deposition layers of the cured film. On the other hand, when the proportion of the organic metal coupling agent is at most 10% by mass, then it is favorable since the composition may be stabilized and may have good film formability.

### (Solvent)

The curable composition for photoimprints of the invention may contain a solvent. The content of the organic solvent in the composition of the invention is at most 2% by mass of the total composition from the viewpoint of process simplification. When the content of the organic solvent is at most 2% by mass, a drying step is not necessary after coating of the composition. When a solvent is contained at an imprint step, a pattern profile may change while the organic solvent is volatized, whereby a good pattern transfer can not be attained.

### (Surfactant)

The curable composition for photoimprints of the invention may contain a surfactant. The content of the surfactant that may be in the composition may be, for example, from 0.001 to 5% by mass of the total amount of the composition, preferably from 0.002 to 4% by mass, more preferably from 0.005 to 3% by mass. In case where two or more different types of surfactants are in the composition, the total amount thereof falls within the above range. When the surfactant content is in the above range, the coating uniformity of the composition is excellent and deterioration of the mold transferability due to excessive amount of the surfactant can be easily avoided.

As the surfactant, preferably, the composition contains at least one of a fluorine-containing surfactant, a silicone-type surfactant and a fluorine-containing silicone-type surfactant, more preferably contains both of a fluorine-containing surfactant and a silicone-type surfactant, or contains a fluorine-containing silicone-type surfactant, most preferably contains a fluorine-containing silicone-type surfactant. A nonionic surfactant is preferably used as the fluorine-containing surfactant and the silicone-type surfactant.

The fluorine-containing silicone-type surfactant as referred to herein means a surfactant satisfying both the requirement of a fluorine-containing surfactant and that of a silicone-type surfactant.

Using the surfactant of the type may solve the problem of coating failures such as striation and flaky pattern formation (drying unevenness of resist film) that may occur when the composition for imprints of the invention is applied onto substrates on which various films are formed, for example, onto silicon wafers in semiconductor production, or onto glass square substrates, chromium films, molybdenum films, molybdenum alloy films, tantalum films, tantalum alloy films, silicon nitride films, amorphous silicon films, tin oxide-doped indium oxide (ITO) films or tin oxide films in production of liquid-crystal devices. In addition, the surfactant is effective for enhancing the flowability of the composition of the invention in the cavity of a female mold, for enhancing the mold-resist releasability, for enhancing the resist adhesiveness to substrates, and for lowering the viscosity of the composition. In particular, when the above-mentioned surfactant is added to the composition for imprints of the invention, the coating uniformity of the composition can be greatly improved; and in coating with it using a spin coater or a slit scan coater, the composition ensures good coating aptitude irrespective of the size of the substrate to which it is applied.

Examples of the nonionic fluorine-containing surfactant usable in the invention include Fluorad FC-430, FC-431 (Sumitomo 3M' s trade names); Surflon S-382 (Asahi Glass's trade name); Eftop EF-122A, 122B, 122C EF-121, EF-126, EF-127, MF-100 (Tochem Products' trade names); PF-636, PF-6320, PF-656, PF-6520 (Omnova Solution's trade names); Futagent FT250, FT251, DFX18 (Neos' trade names); Unidyne DS-401, DS-403, DS-451 (Daikin's trade names); Megafac 171, 172, 173, 178K, 178A, F780F (Dai-Nippon Ink's trade names).

Examples of the nonionic silicone-type surfactant include SI-10 series (Takemoto Yushi's trade name), Megafac Paintad 31 (Dai-Nippon Ink's trade name), KP-341 (Shin-Etsu Chemical's trade name).

Examples of the fluorine-containing silicone-type surfactant include X-70-090, X-70-091, X-70-092, X-70-093 (Shin-Etsu Chemical's trade names); Megafac R-08, XRB-4 (Dai-Nippon Ink's trade names).

### (Antioxidant)

Preferably, the curable composition for photoimprints of the invention comprises an antioxidant. The content of the antioxidant to be in the composition is, for example, from 0.01 to 10% by mass, preferably from 0.2 to 5% by mass of all the solid content in the composition. When two or more different types of antioxidants are in the composition, the total amount thereof falls within the above range.

The antioxidant is for preventing fading by heat or photoirradiation, and for preventing fading by various gases such as ozone, active hydrogen NOx, SOx (x is an integer), etc. Especially in the invention, the antioxidant added to the composition brings about the advantage that the cured film is prevented from being discolored and the film thickness is prevented from being reduced through decomposition. The antioxidant includes hydrazides, hindered amine-type antioxidants, nitrogen-containing heterocyclic mercapto compounds, thioether-type antioxidants, hindered phenol-type antioxidants, ascorbic acids, zinc sulfate, thiocyanates, thiourea derivatives, saccharides, nitrites, sulfites, thiosulfates, hydroxylamine derivatives, etc. Of those, preferred are hindered phenol-type antioxidants and thioether-type antioxidants from the viewpoint of their effect of preventing cured film discoloration and preventing film thickness reduction.

Commercial products of the antioxidant usable herein include Irganox 1010, 1035FF, 1076, 1222 (all by Ciba-Geigy); Antigene P, 3C, FR, Sumilizer S, Sumilizer GA80 (by Sumitomo Chemical); AdekastabA070, A080, A0503, LA52, LA57, LA62, LA63, LA67, LA68LD, LA77 (by Adeka), etc. These may be used either singly or as combined.

### (Other Ingredients)

In addition to the above-mentioned ingredients, the composition of the invention may contain, if desired, non-polymerizable molecule, release agent, polymerization inhibiting agent, UV absorbent, light stabilizer, antiaging agent, plasticizer, adhesion promoter, thermal polymerization initiator, photobase generator, colorant, elastomer particles, photosensitizer, basic compound, flowability promoter, defoaming agent, dispersant, etc.

The composition of the invention may contain the non-polymerizable molecule for the purpose of enhancing adhesiveness and controlling the property of a cured film. The content of the non-polymerizable molecule can be determined so that the content of the photopolymerizable molecule can be within the range of the invention. Examples of the non-polymerizable molecule include an alkyl ester such as dioctyl sebacinate, a (thio)urea compound, organic powder, inorganic powder, etc.

For the purpose of further enhancing the releasability thereof, the composition of the invention may contain a release agent. Concretely, the release agent is added to the composition for the purpose of smoothly releasing the mold pressed to the layer of the composition of the invention not causing surface roughening of the resin layer and not deforming the pattern formed on the layer. The release agent may be any known release agent, including, for example, silicone release agents, solid waxes such as polyethylene wax, amide wax, Teflon® powder, etc., as well as fluorine-containing compounds, phosphate compounds, etc. The release agent may be previously applied to the surface of a mold.

A silicone release agent exhibits especially good mold releasability when combined with the above-mentioned photocurable resin for use in the invention, hardly causing pattern deformation in mold releasing. The silicone release agent has a basic structure of an organopolysiloxane structure, including, for example, native or denatured silicone oil, trimethylsiloxysilicic acid-containing polysiloxane, silicone-type acrylic resin, etc. Ordinary silicone-type leveling agent generally used in hard coat compositions is also usable herein.

Denatured silicone oil is one produced by denaturing the side branch and/or the terminal of polysiloxane, and is grouped into reactive silicone oil and non-reactive silicone oil. The reactive silicone oil includes amino-modified, epoxy-modified, carboxyl-modified, carbinol-modified, methacryl-modified, mercapto-modified, phenol-modified, semiterminal-modified, heterofunctional group-modified ones. The non-reactive silicone oil includes polyether-modified, methylstyryl-modified, alkyl-modified, higher fatty ester-modified, hydrophilic specific-modified, higher alkoxy-modified, higher fatty acid-modified, fluorine-modified ones.

One polysiloxane molecule may have two or more of the above-mentioned denaturation modes. Polyether-modified silicone oils are preferably used from the view point of compatibility to the monomer. Examples of the polyether-modified silicone oil include KF-352A, KF-6004, KF-6012 (by Shin-etsu Chemical), BYK-307, BYK-333, BYK-378 (by BYK Chimie), etc.

Preferably, the denatured silicone oil has suitable compatibility with the constitutive ingredients of the composition of the invention. In particular, in case where a reactive silicone oil that is reactive with the optional constitutive ingredients in the composition of the invention is used in the composition, it may be fixed by chemical bonding in the cured film of the composition, and therefore it may be free from a problem of worsening the adhesiveness of the cured film and from other problems of contamination and degradation of the cured film. In particular, the reactive silicone oil is effective for enhancing the adhesiveness to the vapor-deposition film in an evaporation step. A silicone modified with a photocurable functional group, such as a (meth)acryloyl-modified silicone, a vinyl-modified silicone or the like, may crosslink with the constitutive ingredients of the composition of the invention, and therefore it may enhance the properties of the cured film.

A trimethylsiloxysilicic acid-containing polysiloxane may readily bleed out on the surface of the composition and therefore brings about excellent releasability. In addition, even though it bleeds out on the surface, the polysiloxane of the type still keeps good adhesiveness and is excellent in adhesiveness to a metal-deposition layer and an overcoat layer, and therefore it is favorable for use herein.

One or more different types of the above-mentioned release agents may be used herein either singly or as combined.

In case where the release agent is added to the composition of the invention, its content is preferably from 0.001 to 10% by mass of the total amount of the composition, more preferably from 0.01 to 5% by mass. When the proportion of the release agent is in the range, the mold releasability of the layer of the curable composition for photoimprints of the invention can be improved, and a problem of surface roughening of the coating layer as the composition may be repelled in coating, and problems of worsening the adhesiveness of the composition to substrates themselves or to adjacent layers such as deposit layers in the products or breaking the coating film in transferring (as the film strength is too weak) can be prohibited.

The curable composition of the invention may contain a polymerization inhibitor to improve stability during storage and other properties. Examples of the polymerization inhibitor include phenol compounds such as hydroquinone, tert-butylhydroquinone, catechol, hydroquinone monomethyl ether; quinone compounds such as benzoquinone, diphenylbenzoquinone; phenothiadines; cupper compounds; etc. The content of the polymerization inhibitor is preferably from 0.001 to 10% by mass.

The curable composition of the invention may contain a UV absorbent. Commercial products of UV absorbent usable herein include Tinuvin P, 234, 320, 326, 327, 328, 213 (all by Ciba-Geigy), Sumisorb 110, 130, 140, 220, 250, 300, 320, 340, 350, 400 (all by Sumitomo Chemical Industry), etc. Preferably, the UV absorbent is in the curable composition for photoimprint lithography in an amount falling within a range of from 0.01 to 10% by mass of the total amount of the composition.

The curable composition of the invention may contain a light stabilizer. Commercial products of light stabilizer usable herein include Tinuvin 292, 144, 622 LD (all by Ciba-Geigy), Sanol LS-770, 765, 292, 2626, 1114, 744 (all by Sankyo Chemical Industry), etc. Preferably, the light stabilizer is in the composition in an amount falling within a range of from 0.01 to 10% by mass of the total amount of the composition.

The curable composition of the invention may contain an antiaging agent. Commercial products of antiaging agent usable herein include Antigene W, S, P, 3C, 6C, RD-G, FR, AW (all by Sumitomo Chemical Industry), etc. Preferably, the antiaging agent is in the composition in an amount falling within a range of from 0.01 to 10% by mass of the total amount of the composition.

A plasticizer may be added to the curable composition for photoimprints of the invention for the purpose of controlling the adhesiveness of the composition to substrate, and the flexibility and the hardness of the formed film, etc. Preferred examples of the plasticizer include, for example, dioctyl phthalate, didodecyl phthalate, triethylene glycol dicaprylate, dimethylglycol phthalate, tricresyl phosphate, dioctyl adipate, dibutyl sebacate, triacetylglycerine, dimethyl adipate, diethyl adipate, di(n-butyl) adipate, dimethyl suberate, diethyl suberate, di(n-butyl) suberate, etc. The plasticizer may be in the composition in an amount of at most 30% by mass of the composition. Preferably, the amount is at most 20% by mass, more preferably at most 10% by mass. In order that the plasticizer could exhibit the desired effect thereof, its amount is preferably at least 0.1% by mass.

An adhesiveness promoter may be added to the curable composition for photoimprints of the invention for the purpose of controlling the adhesiveness of the composition to substrate. The adhesiveness promoter includes benzimidazoles, polybenzimidazoles, lower hydroxyalkyl-substituted pyridine derivatives, nitrogen-containing heterocyclic compounds, urea or thiourea, organic phosphorous compounds, 8-hydroxyquinoline, 4-hydroxypteridine, 1,10-phenanthroline, 2,2′-bipyridine derivatives, benzotriazoles, organic phosphorus compounds, phenylenediamine compounds, 2-amino-1-phenylethanol, N-phenylethanolamine, N-ethyldiethanolamine, N-ethyldiethanolamine, N-ethylethanolamine and its derivatives, benzothiazole derivatives, etc. The adhesiveness promoter may be in the composition preferably in an amount of at most 20% by mass of the composition, more preferably at most 10% by mass, even more preferably at most 5% by mass. For attaining the effect of the adhesiveness promoter, the amount thereof is preferably at least 0.1% by mass.

In case where the composition of the invention is cured, a thermal polymerization initiator may be added thereto, if desired. Preferred examples of the thermal polymerization initiator include, for example, peroxides and azo compounds. Specific examples of the compounds are benzoyl peroxide, tert-butyl peroxybenzoate, azobisisobutyronitrile, etc. The content of the thermal polymerization initiator is preferably at most 8.0% by mass, more preferably at most 6.0% by mass, still more preferably at most 4.0% by mass, still more preferably at most 3.0% by mass of the composition.

A photobase generator may be added, if desired, to the curable composition for photoimprints of the invention for the purpose of controlling the patterning profile and the sensitivity of the composition. Preferred examples of the photobase generator include 2-nitrobenzylcyclohexyl carbamate, triphenylmethanol, O-carbamoylhydroxylamide, O-carbamoyl oxime, [[(2,6-dinitrobenzyl)oxy]carbonyl]cyclohexylamine, bis[[(2-nitrobenzyl)oxy]carbonyl]hexane-1,6-diamine, 4-(methylthiobenzoyl)-1-methyl-1-morpholinoethane, (4-morpholinobenzoyl)-1-benzyl-1-dimethylaminopropane, N-(2-nitrobenzyloxycarbonyl)pyrrolidine, hexaammine-cobalt(III) tris(triphenylmethyl borate), 2-benzyl-2-dimethylamino-1-(4-morpholinophenyl)-butanone, 2,6-dimethyl-3,5-diacetyl-4-(2′-nitrophenyl)-1,4-dihydropyr idine, 2,6-dimethyl-3,5-diacetyl-4-(2′,4′-dinitrophenyl)-1,4-dihyd ropyridine, etc.

A colorant may be optionally added to the curable composition for photoimprints of the invention for the purpose of enhancing the visibility of the coating film. As the colorant, herein usable are pigments and dyes that are used in UV inkjet compositions, color filter compositions, CCD image sensor compositions and the like, not detracting from the object of the invention. The pigments usable in the invention may be the materials described in [0121] of JP-A 2008-105414, etc. Preferably, the colorant may be in the composition in an amount of from 0.001 to 2% by mass of the total amount o the composition.

As still another optional ingredient, elastomer particles may be added to the curable composition for photoimprints of the invention for the purpose of enhancing the mechanical strength and the flexibility of the cured film.

The elastomer particles capable of being optionally added to the composition of the invention preferably have a mean particle size of from 10 nm to 700 nm, more preferably from 30 to 300 nm. For example, the elastomer particles are of polybutadiene, polyisoprene, butadiene/acrylonitrile copolymer, styrene/butadiene copolymer, styrene/isoprene copolymer, ethylene/propylene copolymer, ethylene/α-olefin copolymer, ethylene/α-olefin/polyene copolymer, acrylic rubber, butadiene/(meth)acrylate copolymer, styrene/butadiene block copolymer, styrene/isoprene block copolymer, etc. Also usable are core/shell particles prepared by coating these elastomer particles with methyl methacrylate polymer, methyl acrylate/glycidyl methacrylate copolymer or the like. The elastomer particles may have a crosslinked structure.

Commercial products of elastomer particles usable herein are, for example, Resinous Bond RKB (by Resinous Chemical), Techno MBS-61, MBS-69 (by Techno Polymer), etc.

One or more different types of these elastomer particles may be in the composition of the invention either singly or as combined. The content of the elastomer particles in the composition may be preferably from 1 to 35% by mass, more preferably from 2 to 30% by mass, even more preferably from 3 to 20% by mass.

The curable composition for photoimprints of the invention may contain a photosensitizer in addition to the photoradical polymerization initiator to control absorption wavelength in a UV region. Typical sensitizers are described in J. V. Crivello, Adv. in Polymer Sci, 62, 1 (1984). Examples include pyrene, perylene, acyridine orange, thioxanthone, 2-chlorothioxanthone, benzoflavin, N-vinylcarbazol, 9,10-dibutoxyanthracene, anthraquione, coumarin, ketocoumarin, phenanthrene, camphorquinone, phenothiadine, etc.

A basic compound may be optionally added to the curable composition for photoimprints of the invention for the purpose of preventing the composition from shrinking in curing and for enhancing the thermal stability of the composition. The basic compound includes amines, nitrogen-containing heterocyclic compounds such as quinoline, quinolidine, etc., and basic alkali metal compounds, basic alkaline earth metal compounds, etc. Of those, preferred are amines from the viewpoint of the compatibility thereof with photopolymerizable monomers; and for example, they include octylamine, naphthylamine, xylenediamine, dibenzylamine, diphenylamine, dibutylamine, dioctylamine, dimethylaniline, quinuclidine, tributylamine, trioctylamine, tetramethylethylenediamine, tetramethyl-1,6-hexamethylenediamine, hexamethylenetetramine, triethanolamine, etc.

A chain transfer agent may be added to the composition of the invention for enhancing the photocurability of the composition. Concretely, the agent includes 4-bis(3-mercaptobutyryloxy)butane, 1,3,5-tris(3-mercaptobutyloxyethyl)-1,3,5-triazine-2,4,6-(1 H, 3H,5H)-trione, pentaerythritol tetrakis(3-mercaptobutyrate).

The organic solvent includes, for example, alcohols such as methanol, ethanol, etc.; ethers such as tetrahydrofuran, etc.; glycol ethers such as ethylene glycol monomethyl ether, ethylene glycol dimethyl ether, ethylene glycol methylethyl ether, ethylene glycol monoethyl ether, etc.; ethylene glycol alkyl ether acetates such as methyl cellosolve acetate, ethyl cellosolve acetate, etc.; diethylene glycols such as diethylene glycol monomethyl ether, diethylene glycol diethyl ether, diethylene glycol dimethyl ether, diethylene glycol ethylmethyl ether, diethylene glycol monomethyl ether, diethylene glycol monobutyl ether, etc.; propylene glycol alkyl ether acetates such as propylene glycol methyl ether acetate, propylene glycol ethyl ether acetate, etc.; aromatic hydrocarbons such as toluene, xylene, etc.; ketones such as acetone, methyl ethyl ketone, methyl isobutyl ketone, cyclohexanone, 4-hydroxy-4-methyl-2-pentanone, 2-heptanone, etc.; esters such as ethyl 2-hydroxypropionate, methyl 2-hydroxy-2-methylpropionate, ethyl 2-hydroxy-2-methylpropionate, ethyl hydroxyacetate, ethyl hydroxyacetate, methyl 2-hydroxy-2-methylbutanoate, methyl 3-methoxypropionate, ethyl 3-methoxypropionate, methyl 3-ethoxypropionate, ethyl 3-ethoxypropionate, ethyl acetate, butyl acetate, methyl lactate, ethyl lactate, other lactates, etc.

In addition, a high-boiling-point solvent may also be added to the composition; and the solvent includes N-methylformamide, N,N-dimethylformamide, N-methylformanilide, N-methylacetamide, N,N-dimethylacetamide, N-methylpyrrolidone, dimethyl sulfoxide, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, phenyl cellosolve acetate, etc. One or more of these solvents may be in the composition of the invention either singly or as combined.

Of those, especially preferred are methoxypropylene glycol acetate, ethyl 2-hydroxypropionate, methyl 3-methoxypropionate, ethyl 3-ethoxypropionate, ethyl lactate, cyclohexanone, methyl isobutyl ketone, 2-heptanone, etc.

Preferably, the curable composition for photoimprints of the invention has a surface tension falling within a range of from 18 to 30 mN/m, more preferably from 20 to 28 mN/m. When the surface tension of the composition falls within the range, then the cured film may have good surface smoothness.

The water content of the curable composition for photoimprints of the invention in its preparation is preferably at most 2.0% by mass, more preferably at most 1.5% by mass, even more preferably at most 1.0% by mass. When the water content of the composition in its preparation is at most 2.0% by mass, then the storage stability of the composition may be bettered.

### [Method for Producing Cured Product]

A method for producing a cured product using the curable composition for photoimprints of the invention is described below (particularly a method for producing a micropattern with projections and recesses). A micropattern can be formed by applying the curable composition for photoimprints of the invention onto a substrate or a support (base) to form a patterning layer thereon, pressing a mold against the surface of the patterning layer, and irradiating the patterning layer with light to cure the composition of the invention. Particularly, the method of the invention preferably comprises heating the light-irradiated pattering layer to increase the curing degree of the cured product. It is thus preferable that the curable composition for photoimprints of the invention is cured with light and heat.

The cured product obtained by the method for producing a cured product of the invention is excellent in pattern transfer accuracy, curability and light transmittance, and is preferably applicable to a protection film for a liquid crystal color filter, a spacer, and other components for liquid crystal display.

Concretely, the method comprises applying a patterning layer comprising the composition of the invention on a substrate (base or support), drying it to form a layer of the composition of the invention (a patterning layer) as a pattern-receiver if necessary [the patterning layer is formed on the substrate], pressing a mold onto the surface of the patterning layer of the pattern-receiver, processing for mold pattern transfer, and curing a patterning layer having a fine pattern having projections and recesses with irradiation with light and heat. The irradiation with light and heat can be conducted twice or more. Lamination and multi-patterning are possible by the photoimprint lithography with the patterning method of the invention (method for producing a cured product), which can be used with a normal thermal imprint.

As an embodiment of application of the curable composition for photoimprints of the invention, the composition may be applied onto a substrate or a support, then the layer of the composition may be exposed to light, cured and optionally baked, thereby forming a permanent film such as an overcoat layer, an insulation film or the like.

In permanent films (resists for constitutive components) for use in liquid-crystal displays (LCD), the resist is preferably prevented from being contaminated as much as possible with metallic or organic ionic impurities in order that the resist does not interfere with the performance of the displays. Accordingly, the concentration of the impurities is at most 1000 ppm, preferably at most 100 ppm.

Hereinafter, the method for producing a cured product using the curable composition for photoimprints of the invention (pattern forming method (pattern transferring method)) will be specifically described.

In the method for producing a cured product of the invention, the composition of the invention is first applied onto the substrate to form a patterning layer.

The method for providing the curable composition for photoimprints of the invention onto a substrate may be a well known application method through coating of, for example, a dip coating method, an air knife coating method, a curtain coating method, a wire bar coating method, a gravure coating method, an extrusion coating method, a spin coating method, a slit scanning method, etc. The thickness of the patterning method of the composition of the invention may vary depending on the use thereof, and may be from 0.05 μm to 30 μm or so. The composition of the invention may be applied in a mode of multilayer coating. Between the substrate and the patterning method of the composition of the invention, any other organic layer may be formed, such as a planarizing layer, etc. With that, the patterning layer is not kept in direct contact with the substrate, and therefore, the substrate may be prevented from being contaminated with dust or from being scratched.

The substrate or support to which the composition of the invention is applied (preferably coated) is not specifically limited and includes, for example, quartz, glass, optical film, ceramic material, vapor deposition film, magnetic film, reflective film, metal substrate of Ni, Cu, Cr, Fe or the like, paper, spin on glass (SOG), polymer substrate such as polyester film, polycarbonate film or polyimide film, TFT array substrate, PDP electrode plate, glass or transparent plastic substrate, electroconductive substrate of ITO, metal or the like, insulating substrate, semiconductor substrate such as silicon, silicon nitride, polysilicon, silicon oxide or amorphous silicon, which, however, are not limitative. The shape of the substrate may be tabular or roll.

Next, in the method for producing a cured product, a mold is pressed against the surface of the patterning layer in order to transfer the pattern onto the patterning layer. By this step, a micropattern preformed on the surface for press of the mold can be transferred to the patterning layer.

In the photoimprint lithography with the curable composition for photoimprints of the invention, a light-transmissive material is selected for at least one of the mold material and/or the substrate. In the photoimprint lithography applied to the invention, the curable composition for photoimprints of the invention is applied (preferably coated) onto a substrate to form a patterning layer, and a light-transmissive mold is pressed against it, then this is irradiated with light from the back of the mold to thereby cure the patterning layer. Alternatively, the curable composition for photoimprints is applied (preferably coated) onto a light-transmissive substrate, then a mold is pressed against it, and this is irradiated with light from the back of the substrate whereby the curable composition for photoimprints can be cured.

The photoirradiation may be attained while the mold is kept in contact with the composition or after the mold is released. In the invention, preferably, the photoirradiation is attained while the mold is kept in contact with the composition.

The mold usable in the invention has a transferable pattern formed thereon. The pattern of the mold may be formed, for example, through photolithography, electronic beam lithography or the like by which a pattern may be formed to a desired processing accuracy. In the invention, however, the mold patterning method is not specifically defined.

Not specifically defined, the light-transmissive mold material for use in the invention may be any one having a desired strength and durability. Concretely, its examples include glass, quartz, light-transparent resin such as PMMA, polycarbonate resin or the like, transparent metal deposition film, flexible film of polydimethylsiloxane or the like, photocured film, metal film, etc.

The non-light-transmissive mold to be used in the invention where a light-transmissive substrate is used is not also specifically defined and may be any one having a predetermined strength. Concretely, examples of the mold material include ceramic material, deposition film, magnetic film, reflective film, metal material of Ni, Cu, Cr, Fe or the like, as well as SiC, silicon, silicon nitride, polysilicon, silicon oxide, amorphous silicon, etc. However, these are not limitative. The shape of the mold is not specifically limited. The mold may be any of a tabular mold or a roll mold. The roll mold is used especially when continuous production by transferring is desired.

The mold for use in the method for producing a cured product of the invention may be processed for surface release treatment for the purpose of enhancing the releasability of the curable composition for photoimprints of the invention from the mold. The mold of the type includes those surface-treated with a silicone-type or fluorine-containing silane coupling agent, for which, for example, commercial release agents such as Daikin's Optool DSX, Sumitomo 3M' s Novec EGC-1720 and others are preferred.

In photoimprint lithography using the curable composition for photoimprints of the invention, in general, the mold pressure is preferably at most 10 atmospheres. When the mold pressure is at most 10 atmospheres, then the mold and the substrate are hardly deformed and the patterning accuracy tends to increase. It is also favorable since the pressure unit may be small-sized since the pressure to be given to the mold may be low. The mold pressure is preferably selected from the region capable of securing the mold transfer uniformity, within a range within which the residual film of the composition in the area of mold pattern projections may be reduced.

In the method for producing a cured product of the invention, the dose of photoirradiation in the step of irradiation with light on the patterning layer may be sufficiently larger than the dose necessary for curing. The dose necessary for curing may be suitably determined depending on the degree of consumption of the unsaturated bonds in the curable composition for imprints and on the tackiness of the cured film.

In the photoimprint lithography applied to the invention, the substrate temperature in photoirradiation may be room temperature; however, the photoirradiation may be attained under heat for enhancing the reactivity. In the former stage of photoirradiation, preferably, the system is kept in vacuum as effective for preventing contamination with bubbles or for preventing the reduction in reactivity owing to contamination with oxygen, and as effective for enhancing the adhesiveness of the curable composition for photoimprints with mold. The system may be subjected to photoirradiation while still kept in vacuum. In the invention, the vacuum degree is preferably from 10⁻¹ Pa to ordinary pressure.

Light to cure the curable composition for photoimprints of the invention is not specifically defined. For example, it includes light and irradiations with a wavelength falling within a range of high-energy ionizing radiation, near-ultraviolet, far-ultraviolet, visible, infrared, etc. The high-energy ionizing radiation source includes, for example, accelerators such as Cockcroft accelerator, Handegraf accelerator, linear accelerator, betatoron, cyclotron, etc. The electron beams accelerated by such an accelerator are used most conveniently and most economically; however, any other radioisotopes and other radiations are also usable, which are from nuclear reactors, such as γ rays, X rays, a rays, neutron beams, proton beams, etc. The UV sources include, for example, UV fluorescent lamp, low-pressure mercury lamp, high-pressure mercury lamp, ultra-high-pressure mercury lamp, xenon lamp, carbon arc lamp, solar lamp, etc. The radiations include microwaves, EUV, etc. In addition, laser rays for use in microprocessing of semiconductors, such as LED, semiconductor laser ray, 248 nm KrF excimer laser ray, 193 nm ArF excimer laser ray and others, are also favorably used in the invention. These lights may be monochromatic lights, or may also be lights of different wavelengths (mixed lights).

In photoexposure, the light intensity is preferably within a range of from 1 mW/cm² to 50 mW/cm². When the light intensity is at least 1 mW/cm², then the producibility may increase since the photoexposure time may be reduced; and when the light intensity is at most 50 mW/cm², then it is favorable since the properties of the permanent film formed may be prevented from being degraded owing to side reaction. Also preferably, the dose in photoexposure is within a range of from 5 mJ/cm² to 1000 mJ/cm². When the dose is at least 5 mJ/cm², then the photoexposure may be free from a problem of photoexposure margin narrowing and insufficient photoexposure, and also may be free from a problem of unreacted residue adhesion to mold. On the other hand, when the dose is at most 1000 mJ/cm², then it is favorable since the composition may be prevented from being decomposed to degrade the formed permanent film.

Further, in photoexposure, the oxygen concentration in the atmosphere may be controlled to be less than 100 mg/L by introducing an inert gas such as nitrogen or argon into the system for preventing the radical polymerization from being retarded by oxygen.

The method for producing a cured product of the invention preferably comprises heating the cured pattern to cure further (post-bake step) after curing the patterning layer by irradiation with light. The heating can be done before or after releasing the mold from the patterning layer after the irradiation with light. Preferred is heating the patterning layer after releasing the mold. Temperature at the thermal curing of the composition of the invention after irradiation with light is preferably 150 to 280° C., more preferably at 200 to 250° C. The heating time is preferably from 5 to 60 minutes, more preferably from 15 to 45 minutes.

In the invention, the dose of photoirradiation in the photoimprint lithography may be sufficiently larger than the dose necessary for curing. The dose necessary for curing may be suitably determined depending on the degree of consumption of the unsaturated bonds in the curable composition for the photoimprint lithography and on the tackiness of the cured film.

In the photoimprint lithography applied to the invention, the substrate temperature in photoirradiation may be room temperature; however, the photoirradiation may be attained under heat for enhancing the reactivity. In the former stage of photoirradiation, preferably, the system is kept in vacuum as effective for preventing contamination with bubbles or for preventing the reduction in reactivity owing to contamination with oxygen, and as effective for enhancing the adhesiveness of the curable composition for photoimprints with mold. The system may be subjected to photoirradiation while still kept in vacuum. In the invention, the vacuum degree is preferably from 10⁻¹ Pa to ordinary pressure.

The curable composition for photoimprints of the invention may be prepared by mixing the above-mentioned ingredients followed by filtering the resulting mixture through a filter having a pore size of from 0.05 μm to 5.0 μm to give a solution. Mixing and dissolving the ingredients to give the curable composition for photoimprints may be attained generally at a temperature falling within a range of from 0° C. to 100° C. The filtration may be attained in multiple stages, or may be repeated multiple times. The filtrate may be re-filtered. Not specifically defined, the material for use for filtration may be any of polyethylene resin, polypropylene resin, fluororesin, nylon resin, etc.

### [Cured Product]

The cured product thus formed according to the method for producing a cured product of the invention as described in the above can be used as a permanent film (resist for structural members) for use in liquid-crystal displays (LCD) and others, or as an etching resist. After its production, the permanent film may be bottled in a container such as a gallon bottle or a coated bottle, and may be transported or stored. In this case, the container may be purged with an inert gas such as nitrogen, argon or the like for preventing the composition therein from being degraded. The composition may be transported or stored at ordinary temperature, but for preventing the permanent film from being degraded, it is preferably transported or stored at a controlled temperature of from −20° C. to 0° C. Needless-to-say, the composition is shielded from light to such a level on which its reaction does not go on.

The elasticity recovery of the cured product of the invention is preferably at least 70%, more preferably at least 75%, particularly preferably at least 80% from the view point of favorable applicability as a component of a liquid crystal display.

### [Components for Liquid-Crystal Display Devices]

The curable composition for photoimprints of the invention is sued for semiconductor integrated circuits, recording materials, components for liquid-crystal display devices, etc. In particular, it is favorable for components for liquid-crystal display devices, and is especially preferred as an etching resist for sue in flat panel displays, etc.

When the curable composition for photoimprint of the invention is used as a etching resist, a silicon wafer having a thin layer of SiO₂ or others is selected as a substrate, and a fine nanopattern is formed on the substrate according to the method for producing a cured product of the invention. Then, etching is conducted with etching gas, i.e. hydrogen fluoride or the like when wet-etching is chosen and CF₄ or the like when dry-etching is chosen, to form a desired pattern on the substrate.

### EXAMPLES

The characteristics of the invention are described more concretely with reference to Production Examples and Examples given below. In the following Examples, the material used, its amount and the ratio, the details of the treatment and the treatment process may be suitably modified or changed not overstepping the scope of the invention. Accordingly, the invention should not be limitatively interpreted by the Examples mentioned below.

### (Preparation of Curable Composition for Photoimprints)

Compositions shown in the Tables given below, each comprising a photopolymerizable monomer, a compound of the formula (1), a photopolymerization initiator, and optionally a surfactant, a polymer, a silane coupling agent and an antioxidant were prepared by stirring the constitutive ingredients. In the Tables, the unit is % by mass. The materials used are mentioned below. In Comparative Example 10, a composition of Example 1 in JP-A 2007-316247 was prepared.

### <Photopolymerizable Monomer>

M-1: difunctional acrylic monomer, NPGDA (by Nippon Kayaku)
M-2: trifunctional acrylic monomer, M309 (by To a Gosei)
M-3: difunctional acrylic monomer, Biscoat #260 (by Osaka Organic Chemical)
M-4: difunctional acrylic monomer, Biscoat #230 (by Osaka Organic Chemical)
M-5: difunctional acrylic monomer, Biscoat #195 (by Osaka Organic Chemical)
M-6: monofunctional acrylic monomer, Biscoat #155 (by Osaka Organic Chemical)
M-7: tetrafunctional urethane acrylate monomer, U-4HA (by Shin-Nakamura Chemical)
M-8: monofunctional acrylic monomer, glycidylmethacrylate (by Wako Pure Chemicals)
M-9: monofunctional acrylic monomer, Biscoat #160 (by Osaka Organic Chemical)
M-10: monofunctional acrylate monomer, OXE-10 (by Osaka Organic Chemical)
M-11: monofunctional methacrylate monomer, Light Ester CH (Kyoei-Sha)
M-12: monofunctional methacrylate monomer, hexyl methacrylate (by Tokyo Chemical)
M-13: monofunctional methacrylate monomer, Light Ester EH (by Kyoei-sha)<

### <Photopolymerization Initiator>

### I-1: TPO-L (by Nippon Siber)

### <Surfactant>

### W-1: Megafac F780F (by Dai-Nippon Ink)<Release Agent>

### R-1: KF-352A (by Shin-etsu Chemical)

### R-2: BYK-307 (by BYK Chimie)

### R-3: BYK-333 (by BYK Chimie)

### R-4: BYK-378 (by BYK Chimie)<Polymer>

### P-1: AC-SQ (by To a Gosei)<

### Silane Coupling Agent>

### S-1: KBM5103 (by Shin-etsu Chemical)<

### <Antioxidant>

### A0-1: Sumilizer GA-80 (by Sumitomo Chemical)

### A0-2: Irganox 1035FF (by Ciba Specialty Chemical)<

### Compound of the Formula (1)>

The compound of the formula (1) in the invention may be a commercially-available, amino group-having silane coupling agent, or may be synthesized. In case where the compound is synthesized, for example, an amino group-having silane coupling agent may be reacted with a (meth)acryloyl group-having compound by mixing and stirring them to give the intended compound.

SC1: This was produced by mixing 2-ethylhexyl acrylate (2HA, by Mitsubishi Chemical) and KBE903 (by Shin-etsu Chemical) in a ratio by weight of 1/1 and stirring them.

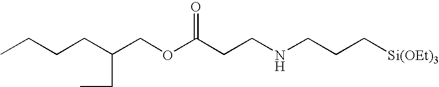

SC2: This was produced by mixing KBM 5103 (by Shin-etsu Chemical) and KBE903 (by Shin-etsu Chemical) in a ratio by weight of 1/1 and stirring them.

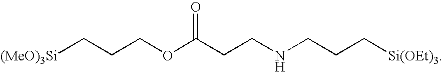

SC3: This was produced by mixing NPGDA (by Nippon Kayaku) and KBE903 (by Shin-etsu Chemical) in a ratio by weight of 1/1 and stirrina them.

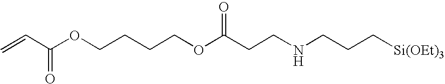

SC4: This was produced by mixing Biscoat #260 (by Osaka Organic Chemical) and KBE903 (by Shin-etsu Chemical) in a ratio by weight of 1/1 and stirring them.

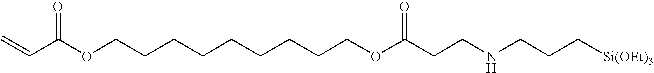

### SC5: KBE903 (by Shin-etsu Chemical)

(CH₃O)₃SiC₃H₆NH₂

### <Adhesiveness to Substrate>

The composition was applied to a glass substrate by spin coating to form a layer having a thickness of 3.0 μm thereon. With no mold attached thereto, this was exposed to light of 200 mJ/cm² in a nitrogen atmosphere to form a cured film.

The film was tested for the adhesiveness according to a tape peeling method (JIS C 0806-3, 1999). The tape used in the test had a width of 12 mm. The test confirms the adhesiveness of the composition to the substrate after exposure and before curing.

5: tape peeling force, 30 g/12 mm or more.
4: tape peeling force, from 20 g/12 mm to less than 30 g/12 mm.
3: tape peeling force, from 10 g/12 mm to less than 20 g/12 mm.
2: tape peeling force, from 5 g/12 mm to less than 10 g/12 mm.
1: tape peeling force, less than 5 g/12 mm.

### <Temporal Stability>

The viscosity of the composition was measured to evaluate the temporal stability thereof. Before cured, the viscosity of the composition was measured with a rotary viscometer, Toki Sangyo's RE-80L Model, at 25±0.2° C. The revolution speed in measurement was 100 rpm for a range of from 0.5 mPa·s to less than 5 mPa·s; 50 rpm for a range of from 5 mPa19 s to less than 10 mPa·s; 20 rpm for a range of from 10 mPa·s to less than 30 mPa·s; 10 rpm for a range of from 30 mPa·s to less than 60 mPa·s.

5: The viscosity increase in storage for 3 days at 5° C. was from 0% to less than 1%.
4: The viscosity increase in storage for 3 days at 5° C. was from 1% to less than 3%.
3: The viscosity increase in storage for 3 days at 5° C. was from 3% to less than 5%.
2: The viscosity increase in storage for 3 days at 5° C. was from 5% to less than 10%.
1: The viscosity increase in storage for 3 days at 5° C. was 10% or more.

### <Imprintability>

The pattern transferred onto the resist was checked for the reproducibility for the original mold pattern. Concretely, the composition was applied onto a glass substrate by spin coating to form a layer having a thickness of 3.0 μm thereon. The spin-coated substrate was set in a nanoimprinting device with a light source of a high-pressure mercury lamp (by ORC) (lamp power, 2000 mW/cm²), in which the mold was formed of polydimethylsiloxane (Toray Dow-Corning's SILGARD 184, cured at 80° C. for 60 minutes) and had a line/space pattern of 10 μm with a groove depth of 4.0 μm, the mold pressure was 0.8 kN and the vacuum degree during photoexposure was 10 Torr (about 1.33×10⁴ Pa). Under the condition, the mold was pressed against the resist, and exposed to light (200 mJ/cm²) through the surface of the mold. After the photoexposure, the mold was removed, and the resist pattern was thus formed.

Further, the obtained resist pattern was baked in an oven at 230° C. for 30 minutes and was thus completely cured. The transferred pattern profile was observed with a scanning electronic microscope and an optical microscope, and the pattern profile was evaluated according to the following standards.

5: mold profile transfer ratio, 95% or more.
4: mold profile transfer ratio, from 90% to less than 95%.
3: mold profile transfer ratio, from 80% to less than 90%.
2: mold profile transfer ratio, from 70% to less than 80%.
1: mold profile transfer ratio, less than 70%.

The test results are shown in Table 1 and Table 2.

TABLE 1

| | | | Example 1 | Example 2 | Example 3 | Example 4 | Example 5 | Example 6 | Example 7 | Example 8 | Example 9 |
|---|---|---|---|---|---|---|---|---|---|---|---|
| Composition | Photopolymerizable | M-1 | 62.0 | 62.0 | 62.0 | 62.0 | 62.0 | 62.0 | 62.0 | 62.0 | 62.0 |
| | Monomer | M-2 | 34.5 | 33.8 | 32.5 | 30.4 | 25.3 | 33.8 | 32.5 | 30.4 | 33.8 |
| | Compound of | SC1 | 0.5 | 1.2 | 2.5 | 4.6 | 9.7 | | | | |
| | Formula (1) | SC2 | | | | | | 1.2 | 2.5 | 4.6 | |
| | | SC3 | | | | | | | | | 1.2 |
| | | SC4 | | | | | | | | | |
| | | SC5 | | | | | | | | | |
| | Polymer | P-1 | | | | | | | | | |
| | Polymerization | I-1 | 2.0 | 2.0 | 2.0 | 2.0 | 2.0 | 2.0 | 2.0 | 2.0 | 2.0 |
| | Initiator | | | | | | | | | | |
| | Surfactant | W-1 | 1.0 | 1.0 | 1.0 | 1.0 | 1.0 | 1.0 | 1.0 | 1.0 | 1.0 |
| | Total | | 100.0 | 100.0 | 100.0 | 100.0 | 100.0 | 100.0 | 100.0 | 100.0 | 100.0 |
| Test Result | Adhesiveness to Substrate | | 3 | 4 | 4 | 4 | 5 | 4 | 5 | 5 | 5 |
| | Temporal Stability | | 5 | 5 | 5 | 4 | 3 | 4 | 4 | 3 | 5 |
| | Imprintability | | 5 | 5 | 5 | 5 | 5 | 5 | 5 | 5 | 5 |
| | | | Example | Example | Example | Example | Example | Example | Example | Example | Example |
| | | | 10 | 11 | 12 | 13 | 14 | 15 | 16 | 17 | 18 |
| Composition | Photopolymerizable | M-1 | 62.0 | 62.0 | 62.0 | 62.0 | 62.0 | 62.0 | 62.0 | 58.0 | 54.0 |
| | Monomer | M-2 | 32.5 | 30.4 | 33.8 | 32.5 | 30.4 | 32.5 | 30.4 | 32.5 | 32.5 |
| | Compound of | SC1 | | | | | | | | | |
| | Formula (1) | SC2 | | | | | | | | | |
| | | SC3 | 2.5 | 4.6 | | | | | | 2.5 | 2.5 |
| | | SC4 | | | 1.2 | 2.5 | 4.6 | | | | |
| | | SC5 | | | | | | 2.5 | 4.6 | | |
| | Polymer | P-1 | | | | | | | | 4.0 | 8.0 |
| | Polymerization | I-1 | 2.0 | 2.0 | 2.0 | 2.0 | 2.0 | 2.0 | 2.0 | 2.0 | 2.0 |
| | Initiator | | | | | | | | | | |
| | Surfactant | W-1 | 1.0 | 1.0 | 1.0 | 1.0 | 1.0 | 1.0 | 1.0 | 1.0 | 1.0 |
| | Total | | 100.0 | 100.0 | 100.0 | 100.0 | 100.0 | 100.0 | 100.0 | 100.0 | 100.0 |

| | | | | | | | | | | |
|---|---|---|---|---|---|---|---|---|---|---|
| Test Result | Adhesiveness to Substrate | 5 | 5 | 5 | 5 | 5 | 3 | 4 | 4 | 4 |
| | Temporal Stability | 5 | 5 | 5 | 5 | 5 | 3 | 3 | 3 | 3 |
| | Imprintability | 5 | 5 | 5 | 5 | 5 | 5 | 5 | 4 | 3 |

t>

TABLE 2

| | | | Com- | Com- | Com- | Com- | Com- | Com- | Com- | Com- | Com- | Com- |
|---|---|---|---|---|---|---|---|---|---|---|---|---|
| | | | parative | parative | parative | parative | parative | parative | parative | parative | parative | parative |
| | | | Exam- | Exam- | Exam- | Exam- | Exam- | Exam- | Exam- | Exam- | Exam- | Exam- |
| | | | ple 1 | ple 2 | ple 3 | ple 4 | ple 5 | ple 6 | ple 7 | ple 8 | ple 9 | ple 10 |
| Com- | Photopolymerizable | M-1 | 62.0 | 62.0 | 62.0 | 62.0 | 62.0 | 62.0 | 62.0 | 62.0 | 50.0 | Example 1 in |
| position | Monomer | M-2 | 35.0 | 34.8 | 24.2 | 21.0 | 24.2 | 24.2 | 24.2 | 24.2 | 30.4 | JP-A |
| | Compound of | SC1 | | 0.2 | 10.8 | 14.0 | | | | | | 2007-316247 |
| | Formula (1) | SC2 | | | | | 10.8 | | | | | |
| | | SC3 | | | | | | 10.8 | | | | |
| | | SC4 | | | | | | | 10.8 | | | |
| | | SC5 | | | | | | | | 10.8 | 4.6 | |
| | Polymer | P-1 | | | | | | | | | 12.0 | |
| | Polymerization | I-1 | 2.0 | 2.0 | 2.0 | 2.0 | 2.0 | 2.0 | 2.0 | 2.0 | 2.0 | |
| | Initiator | | | | | | | | | | | |
| | Surfactant | W-1 | 1.0 | 1.0 | 1.0 | 1.0 | 1.0 | 1.0 | 1.0 | 1.0 | 1.0 | |

| | | | | | | | | | | | |
|---|---|---|---|---|---|---|---|---|---|---|---|
| | Total | 100.0 | 100.0 | 100.0 | 100.0 | 100.0 | 100.0 | 100.0 | 100.0 | 100.0 | |
| Test | Adhesiveness to Substrate | 1 | 2 | 5 | 5 | 5 | 5 | 5 | 5 | 5 | 5 |
| Result | Temporal Stability | 5 | 5 | 2 | 1 | 1 | 2 | 2 | 2 | 5 | 5 |
| | Imprintability | 1 | 1 | 5 | 5 | 5 | 5 | 5 | 5 | 1 | 1 |

An urethane acrylate was added to the composition of the invention and its effect for increasing the adhesiveness of the composition to an inorganic film was confirmed. Concretely, compositions shown in the Table below were prepared, and their adhesiveness to an ITO film was evaluated. The results are shown in Table 3 and Table 4. The applications where the adhesiveness of the composition to inorganic film is required are limited; and therefore, even though the ITO adhesiveness level of the composition is low, the composition could be still favorable for other applications where the adhesiveness thereof to inorganic film is not specifically required.

### <Adhesiveness to ITO>

This is to evaluate the adhesiveness of the composition of the invention to ITO. Briefly, an ITO film formed on a resist of the composition was etched and evaluated as to how and to what degree the formed pattern profile changed from the etching resist.

The composition was applied to a glass substrate by spin coating to form a layer having a thickness of 3.0 μm thereon. With no mold attached thereto, this was exposed to light of 10 mW and 200 mJ/cm² in a nitrogen atmosphere, and then this was cured by heating in an oven at 230° C. for 15 minutes.

ITO was sputtered on the cured film at a substrate temperature of 25° C., thereby forming an ITO film having a thickness of 500 nm.

Next, using an etching resist of an ordinary positive resist, a line pattern having a line width of 50 μm was formed on the film. Then, using an etchant (Clean Etch ITO, by Hayashi Pure Chemicals), this was wet-etched at 40° C. for 5 minutes.

After the wet-etching treatment, the line width of the remaining ITO was measured. The line width was subtracted from the line width, 50 μm of the etching resist of the positive resist, and the resulting value is the side etch, which is the factor of evaluating the adhesiveness of the tested composition to ITO.

In general, when the adhesiveness of the resist to ITO is poor, the line width of the remaining ITO is smaller than the line width of the positive resist.

5: side etch, less than 2 μm.
4: side etch, from 2 μm to less than 5 μm
3: side etch, from 5 μm to less than 10 μm
2: side etch, from 10 μm to less than 20 μm
1: side etch, 20 μm or more

TABLE 3

| | | | Example | Example | Example | Example | Example | Example | Example |
|---|---|---|---|---|---|---|---|---|---|
| | | | 19 | 20 | 21 | 22 | 23 | 24 | 25 |
| Composition | Photopolymerizable | M-2 | 28.4 | 38.4 | 38.4 | 38.4 | 28.4 | 38.4 | 38.4 |
| | Monomer | M-3 | 9.0 | 9.0 | 9.0 | 9.0 | 9.0 | 9.0 | 9.0 |
| | | M-4 | | | 10.0 | 20.0 | 20.0 | | |
| | | M-5 | | | | | | | 10.0 |
| | | M-6 | 42.2 | 32.2 | 22.2 | 12.2 | 22.2 | 22.2 | 22.2 |
| | | M-7 | 5.0 | 5.0 | 5.0 | 5.0 | 5.0 | 5.0 | 5.0 |
| | Compound of Formula (1) | SC4 | 2.0 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 | 2.0 |
| | Release Agent | R-1 | 1.0 | 1.0 | 1.0 | 1.0 | 1.0 | 1.0 | 1.0 |
| | Antioxidant | AO-1 | 0.2 | 0.2 | 0.2 | 0.2 | 0.2 | 0.2 | 0.2 |
| | | AO-2 | 0.2 | 0.2 | 0.2 | 0.2 | 0.2 | 0.2 | 0.2 |
| | Total | | 100.0 | 100.0 | 100.0 | 100.0 | 100.0 | 100.0 | 100.0 |
| Test Result | Adhesiveness to Substrate | | 5 | 5 | 5 | 5 | 5 | 5 | 5 |
| | Temporal Stability | | 5 | 5 | 5 | 5 | 5 | 5 | 5 |
| | Imprintability | | 5 | 5 | 5 | 5 | 5 | 5 | 5 |
| | Adhesiveness to ITO | | 4 | 4 | 4 | 4 | 4 | 4 | 4 |
| | | | Example | Example | Example | Example | Example | Example | Example |
| | | | 26 | 27 | 28 | 29 | 30 | 31 | 32 |
| Composition | Photopolymerizable | M-2 | 38.4 | 23.4 | 31.4 | 33.4 | 33.4 | 41.4 | 43.4 |
| | Monomer | M-3 | 9.0 | 9.0 | 9.0 | 9.0 | 9.0 | 9.0 | 9.0 |
| | | M-4 | | | | | 10.0 | 10.0 | 10.0 |
| | | M-5 | 20.0 | | | | | | |
| | | M-6 | 12.2 | 42.2 | 42.2 | 42.2 | 22.2 | 22.2 | 22.2 |
| | | M-7 | 5.0 | 10.0 | 2.0 | | 10.0 | 2.0 | |
| | Compound of Formula (1) | SC4 | 2.0 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 | 2.0 |
| | Release Agent | R-1 | 1.0 | 1.0 | 1.0 | 1.0 | 1.0 | 1.0 | 1.0 |
| | Antioxidant | AO-1 | 0.2 | 0.2 | 0.2 | 0.2 | 0.2 | 0.2 | 0.2 |
| | | AO-2 | 0.2 | 0.2 | 0.2 | 0.2 | 0.2 | 0.2 | 0.2 |
| | Total | | 100.0 | 100.0 | 100.0 | 100.0 | 100.0 | 100.0 | 100.0 |
| Test Result | Adhesiveness to Substrate | | 5 | 5 | 5 | 5 | 5 | 5 | 5 |
| | Temporal Stability | | 5 | 5 | 5 | 5 | 5 | 5 | 5 |
| | Imprintability | | 5 | 3 | 5 | 5 | 3 | 5 | 5 |
| | Adhesiveness to ITO | | 4 | 5 | 3 | 1 | 5 | 3 | 1 |

TABLE 4

| | | | Example 33 | Example 34 | Example 35 | Example 36 | Example 37 | Example 38 |
|---|---|---|---|---|---|---|---|---|
| Composition | Photopolymerizable | M-2 | 38.4 | 38.4 | 38.4 | 38.4 | 38.4 | 38.4 |
| | Monomer | M-3 | 9.0 | 9.0 | 9.0 | 9.0 | 9.0 | 9.0 |
| | | M-4 | 15.0 | 10.0 | 5.0 | 15.0 | 10.0 | 5.0 |
| | | M-7 | 5.0 | 5.0 | 5.0 | 5.0 | 5.0 | 5.0 |
| | | M-8 | 17.2 | 22.2 | 27.2 | | | |
| | | M-9 | | | | 17.2 | 22.2 | 27.2 |
| | | M-10 | | | | | | |
| | Compound of Formula (1) | SC4 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 |
| | Release Agent | R-1 | 1.0 | 1.0 | 1.0 | 1.0 | 1.0 | 1.0 |
| | Antioxidant | AO-1 | 0.2 | 0.2 | 0.2 | 0.2 | 0.2 | 0.2 |
| | | AO-2 | 0.2 | 0.2 | 0.2 | 0.2 | 0.2 | 0.2 |
| | Total | | 100.0 | 100.0 | 100.0 | 100.0 | 100.0 | 100.0 |
| Test Result | Adhesiveness to Substrate | | 5 | 5 | 5 | 5 | 5 | 5 |
| | Temporal Stability | | 5 | 5 | 5 | 5 | 5 | 5 |
| | Imprintability | | 5 | 5 | 5 | 5 | 5 | 5 |
| | Adhesiveness to ITO | | 4 | 4 | 4 | 4 | 4 | 4 |
| | | | Example 39 | Example 40 | Example 41 | Example 42 | Example 43 | Example 44 |
| Composition | Photopolymerizable | M-2 | 38.4 | 38.4 | 38.4 | 38.4 | 38.4 | 38.4 |
| | Monomer | M-3 | 9.0 | 9.0 | 9.0 | 9.0 | 9.0 | 9.0 |
| | | M-4 | 15.0 | 10.0 | 5.0 | 15.0 | 10.0 | 5.0 |
| | | M-7 | 5.0 | 5.0 | 5.0 | 5.0 | 5.0 | 5.0 |
| | | M-8 | 8.6 | 11.1 | 13.6 | | | |
| | | M-9 | 8.6 | 11.1 | 13.6 | | | |
| | | M-10 | | | | 17.2 | 22.2 | 27.2 |
| | Compound of Formula (1) | SC4 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 |
| | Release Agent | R-1 | 1.0 | 1.0 | 1.0 | 1.0 | 1.0 | 1.0 |
| | Antioxidant | AO-1 | 0.2 | 0.2 | 0.2 | 0.2 | 0.2 | 0.2 |
| | | AO-2 | 0.2 | 0.2 | 0.2 | 0.2 | 0.2 | 0.2 |
| | Total | | 100.0 | 100.0 | 100.0 | 100.0 | 100.0 | 100.0 |
| Test Result | Adhesiveness to Substrate | | 5 | 5 | 5 | 5 | 5 | 5 |
| | Temporal Stability | | 5 | 5 | 5 | 5 | 5 | 5 |
| | Imprintability | | 5 | 5 | 3 | 5 | 5 | 5 |
| | Adhesiveness to ITO | | 4 | 4 | 5 | 4 | 4 | 4 |

TABLE 5

| | | | Example 45 | Example 46 | Example 47 | Example 48 | Example 49 | Example 50 |
|---|---|---|---|---|---|---|---|---|
| Composition | Photopolymerizable | M-2 | 38.4 | 38.4 | 38.4 | 38.4 | 38.4 | 38.4 |
| | Monomer | M-3 | 9.0 | 9.0 | 9.0 | 9.0 | 9.0 | 9.0 |
| | | M-4 | 10.0 | 10.0 | 10.0 | 10.0 | 10.0 | 10.0 |
| | | M-7 | 5.0 | 5.0 | 5.0 | 5.0 | 5.0 | 5.0 |
| | | M-11 | 22.2 | 22.2 | 22.2 | 22.2 | | |
| | | M-12 | | | | | 22.2 | 22.2 |
| | | M-13 | | | | | | |
| | Compound of Formula (1) | SC4 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 |
| | Release Agent | R-1 | 1.0 | | | | 1.0 | |
| | | R-2 | | 1.0 | | | | 1.0 |
| | | R-3 | | | 1.0 | | | |
| | | R-4 | | | | 1.0 | | |
| | Antioxidant | AO-1 | 0.2 | 0.2 | 0.2 | 0.2 | 0.2 | 0.2 |
| | | AO-2 | 0.2 | 0.2 | 0.2 | 0.2 | 0.2 | 0.2 |
| | Total | | 100.0 | 100.0 | 100.0 | 100.0 | 100.0 | 100.0 |
| Test Result | Adhesiveness to Substrate | | 5 | 5 | 5 | 5 | 5 | 5 |
| | Temporal Stability | | 5 | 5 | 5 | 5 | 5 | 5 |
| | Imprintability | | 5 | 5 | 5 | 5 | 5 | 5 |
| | Adhesiveness to ITO | | 4 | 4 | 4 | 4 | 4 | 4 |
| | | | Example 51 | Example 52 | Example 53 | Example 54 | Example 55 | Example 56 |
| Composition | Photopolymerizable | M-2 | 38.4 | 38.4 | 38.4 | 38.4 | 38.4 | 38.4 |
| | Monomer | M-3 | 9.0 | 9.0 | 9.0 | 9.0 | 9.0 | 9.0 |
| | | M-4 | 10.0 | 10.0 | 10.0 | 10.0 | 10.0 | 10.0 |
| | | M-7 | 5.0 | 5.0 | 5.0 | 5.0 | 5.0 | 5.0 |
| | | M-11 | | | | | | |
| | | M-12 | 22.2 | 22.2 | | | | |
| | | M-13 | | | 22.2 | 22.2 | 22.2 | 22.2 |
| | Compound of Formula (1) | SC4 | 2.0 | 2.0 | 2.0 | 2.0 | 2.0 | 2.0 |
| | Silane Coupling Agent | S-1 | 10.0 | 10.0 | 10.0 | 10.0 | 10.0 | 10.0 |
| | Polymerization Initiator | I-1 | 2.0 | 2.0 | 2.0 | 2.0 | 2.0 | 2.0 |
| | Release Agent | R-1 | | | 1.0 | | | |
| | | R-2 | | | | 1.0 | | |
| | | R-3 | 1.0 | | | | 1.0 | |
| | | R-4 | | 1.0 | | | | 1.0 |
| | Antioxidant | AO-1 | 0.2 | 0.2 | 0.2 | 0.2 | 0.2 | 0.2 |
| | | AO-2 | 0.2 | 0.2 | 0.2 | 0.2 | 0.2 | 0.2 |
| | Total | | 100.0 | 100.0 | 100.0 | 100.0 | 100.0 | 100.0 |
| Test Result | Adhesiveness to Substrate | | 5 | 5 | 5 | 5 | 5 | 5 |
| | Temporal Stability | | 5 | 5 | 5 | 5 | 5 | 5 |
| | Imprintability | | 5 | 5 | 5 | 5 | 5 | 5 |
| | Adhesiveness to ITO | | 4 | 4 | 4 | 4 | 4 | 4 |

As is obvious from the above Tables, the compositions of the invention were all excellent in imprintability and in adhesiveness to substrate and temporal stability. On the other hand, the comparative compositions were extremely poor in imprintability or extremely poor in temporal stability. The composition of Comparative Example 10 is one described in JP-A 2007-316247 (Patent Reference 1), and this was insufficient in imprintability as containing a polymer. In addition, the test results confirmed the enhanced adhesiveness to an inorganic film of the composition containing urethane (meth)acrylate added thereto. From these results, it is known that the compositions which are seemingly similar to the compositions of the invention but are outside the scope of the invention are extremely poor in imprintability.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2009-074969 filed on Mar. 25, 2009, Japanese Patent Application No. 2009-170986 filed on Jul. 22, 2009, Japanese Patent Application No. 2009-189066 filed on Aug. 18, 2009, and Japanese Patent Application No. 2009-233517 filed on Oct. 7, 2009, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A curable composition for photoimprints comprising a photopolymerizable monomer, a polymerization initiator and a compound of the following formula (1), wherein the content of compounds having a molecular weight of at least 1000 is at most 10% by mass of all the solid content therein, and the content of the compound of the formula (1) is from 0.3 to 10.0% by mass of all the solid content therein: 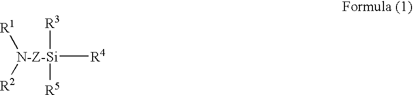
wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; and R⁵ represents a methoxy group or an ethoxy group.

2. The curable composition for photoimprints according to claim 1, wherein Z in the formula (1) is a linear or branched hydrocarbon group.

3. The curable composition for photoimprints according claim 1, wherein Z in the formula (1) is an alkylene group.

4. The curable composition for photoimprints according to claim 1, wherein Z in the formula (1) is an aliphatic hydrocarbon group having from 1 to 5 carbon atoms.

5. The curable composition for photoimprints according claim 1, wherein at least one of R¹ and R² in the formula (1) is a substituent containing a (meth)acryloyloxy group.

6. The curable composition for photoimprints according to claim 1, wherein at least one of R¹ and R² in the formula (1) is a substituent containing an alkoxysilyl group.

7. The curable composition for photoimprints according to claim 1, wherein the compound of the formula (1) is a compound represented by the following formula (2): 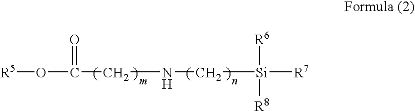
wherein R⁵ represents a substituent, R⁶ and R⁷ each independently represent a methyl group, an ethyl group, a methoxy group or an ethoxy group; R⁸ represents a methoxy group or an ethoxy group; m and n each independently indicate an integer of from 1 to 4.

8. The curable composition for photoimprints according to claim 7, wherein R⁵ has a (meth)acryloyloxy group.

9. The curable composition for photoimprints according to claim 7, wherein R⁵ is a (meth)acryloyloxyalkyl group.

10. The curable composition for photoimprints according claim 7, wherein R⁵ has an alkoxysilyl group.

11. The curable composition for photoimprints according to claim 7, wherein R⁵ is an alkoxysilylalkyl group.

12. The curable composition for photoimprints according to claim 1, further comprising a surfactant.

13. The curable composition for photoimprints according to claim 1, wherein at least one of the photopolymerizable monomer is an urethane (meth)acrylate monomer.

14. The curable composition for photoimprints according to claim 13, wherein the urethane (meth)acrylate is tri- or more functional.

15. The curable composition for photoimprints according to claim 13, wherein the content of the urethane (meth)acrylate is from 1 to 30% by weight of the total amount of the photopolymerizable monomer.

16. A method for producing a cured product, comprising using a curable composition for photoimprints comprising a photopolymerizable monomer, a polymerization initiator and a compound of the following formula (1), wherein the content of compounds having a molecular weight of at least 1000 is at most 10% by mass of all the solid content therein, and the content of the compound of the formula (1) is from 0.3 to 10.0% by mass of all the solid content therein: 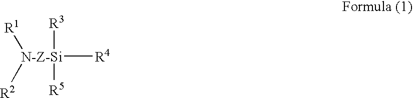
wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; and R⁵ represents a methoxy group or an ethoxy group.

17. A method for producing a cured product, comprising:
applying a curable composition for photoimprints onto a substrate to form a patterning layer thereon, wherein the curable composition for photoimprints comprises a photopolymerizable monomer, a polymerization initiator and a compound of the following formula (1), wherein the content of compounds having a molecular weight of at least 1000 is at most 10% by mass of all the solid content therein, and the content of the compound of the formula (1) is from 0.3 to 10.0% by mass of all the solid content therein: 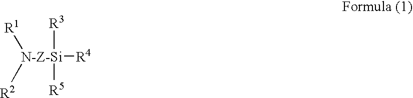
wherein Z represents an aliphatic hydrocarbon group; R¹ and R² each independently represent a hydrogen atom or a substituent; R³ and R⁴ each independently represent a methyl group, an ethyl group, a methoxy group or an ethoxy group; and R⁵ represents a methoxy group or an ethoxy group,
pressing a mold against the surface of the patterning layer, and
irradiating the patterning layer with light.

18. The method for producing a cured product according to claim 17, further comprising heating the light-irradiated pattering layer.

19. The method for producing a cured product according to claim 17, wherein a pattern in a size of from 1 nm to 10 mm on the mold is transferred to the patterning layer.

20. The method for producing a cured product according to claim 17, wherein a pattern in a size of from 10 nm to 100 μm on the mold is transferred to the patterning layer.
